(19) United States
(12) Patent Application Publication
(10) Pub. No.: US 2025/0241246 A1
(43) Pub. Date: Jul. 31, 2025

(54) GRAIN CART UNLOADING SENSOR AND UNLOAD CONTROL SYSTEM AND ASSOCIATED DEVICES AND METHODS

(71) Applicant: Ag Leader Technology, Ames, IA (US)

(72) Inventors: Tony Woodcock, Ames, IA (US); Scott Elchhorn, Ames, IA (US); Roger Zielke, Huxley, IA (US); John Hall, Ankey, IA (US); Aaron Friedlein, Farmersburg, IA (US)

(21) Appl. No.: 19/041,787

(22) Filed: Jan. 30, 2025

Related U.S. Application Data
(60) Provisional application No. 63/626,744, filed on Jan. 30, 2024.

(51) Int. Cl. A01D 90/10; B65G 33/14; G05D 9/12

(52) U.S. Cl. CPC A01D 90/105; B65G 33/14; G05D 9/12; B65G 2201/042

(57) ABSTRACT

A grain unloading monitoring system for use in operations moving grain from a grain cart to a grain truck or container utilizing at least one sensor configured to monitor a grain level within a grain container, a processor in electronic communication with the at least one sensor, and a command module in electronic communication with the processor. The command module is configured to command one or more components on a grain cart or grain container to distribute unloaded grain and prevent overfilling of the grain container based on the monitored grain level and grain fill rate.

### CROSS-REFERENCE TO RELATED APPLICATION(S)

This application claims the benefit under 35 U.S.C. § 119(e) to U.S. Provisional Application 63/626,744, filed Jan. 30, 2024, and entitled Grain Cart Unloading Sensor and Unload Control, which is hereby incorporated herein by reference in its entirety for all purposes.

### TECHNICAL FIELD

The disclosure relates to agricultural implements and positions sensors for use therewith.

### BACKGROUND

It is understood by those skilled in the art that a grain cart is a mobile grain storage container used to unload a combine harvester. Grain carts are typically pulled by an agricultural tractor. The term “grain cart” hereinafter refers to the pulling tractor and the grain cart. A grain cart shuttles grain from the combine to another hauling vehicle parked at the field edge. The receiving or hauling vehicle is typically a truck or wagon suited to haul grain away from the field on a roadway. The term “truck” or “grain truck” hereinafter refers to the hauling truck or wagon.

Most trucks have a tarp that can be rolled over the top of the grain container. It keeps the grain from blowing onto the roadway and protects the grain from precipitation (e.g. rain, snow, etc). Support members span across the grain container to provide a structure for the tarp to roll across. If grain is piled above the tarp supports, the tarp can not be able to close. The only resolution is for someone to climb on top of the grain pile and scoop the grain below the tarp support. This is an undesired, cumbersome task that slows down the trucking process. Therefore, grain cart operators try to keep the top of the grain pile at or below the tarp supports.

The tractor operator makes two adjustments to set the unload rate. First, the operator sets the unload auger speed by adjusting the tractor engine RPM. The unloading auger is driven by the tractor's PTO shaft which is driven by the tractor engine. Increasing tractor engine RPM causes the unload auger RPM to increase. This dispenses more grain into the truck per unit of time. Decreasing engine RPM decreases the dispensing rate. Second, the operator opens a hydraulically actuated gate that controls the amount of grain that flows into the unload auger. Opening the gate increases the grain dispensing rate into the truck. Closing the gate decreases the dispensing rate. The operator uses a tractor SCV valve to adjust the gate opening.

The normal practice is to start unloading at one end of the truck and move the grain cart forward (or backward) as the grain piles up in the truck. Experienced grain cart operators set and leave the gate fully open to hasten the unload. The difficulty is that the fast unload rate fills up the top part of the truck within seconds. A few seconds delay to pull ahead will pile grain above the tarp supports and/or spill grain over the truck sides. This puts stress on the tractor operator to pull ahead at just the right moment, which requires an experienced operator. They don't usually spill if they are paying attention. Inexperienced operators often spill with a fully open gate because they don't pull the grain cart ahead soon enough. Because of this, some operators unload at a slower rate, which delays returning to the combine.

Another difficulty is filling the last part of the truck. What's difficult is the unloading auger needs to become empty the moment the truck becomes completely full. This is because the auger driveline can not be able to turn the auger on the next unload if it is full of grain. Part of the difficulty is the auger takes several seconds to clean out after the gate is closed. To reduce the difficulty, operators partially close the gate when filling the last part of the truck. This slows the grain unload rate to a manageable level, but it delays returning to the combine.

What's needed is a system that automates part or all the grain cart unload process. This will reduce stress on the grain cart operator which makes operating the cart easier and less tiring. It can also enable less skilled operators to operate the grain cart. Enabling less skilled operators enlarges the potential grain cart labor pool. This is a welcome benefit because skilled farm machine operators are hard to find.

### BRIEF SUMMARY

This disclosure pertains to unloading a grain cart into a truck. The grain cart needs to unload quickly so it can return and unload the combine before the combine gets full. Because of this, grain carts are designed to quickly unload large amounts of grain.

In various implementations of the disclosed Examples, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Other embodiments of these Examples include corresponding computer systems, apparatus, and computer programs recorded on one or more computer storage devices, each configured to perform the actions of the methods.

In Example 1, a grain unloading monitoring system comprising, at least one sensor configured to monitor a grain level within a grain container, a processor in electronic communication with the at least one sensor, and a command module in electronic communication with the processor, the command module configured to command one or more components on a grain cart or grain container to distribute unloaded grain and prevent overfilling of the grain container based on the monitored grain level and grain fill rate.

In Example 2, the grain unloading monitoring system of claim 1, wherein the processor is configured to determine a grain fill rate.

In Example 3, the grain unloading monitoring system of claim 1, wherein the one or more components comprise an auger and a gate.

In Example 4, the grain unloading monitoring system of claim 3, wherein the system is configured to slow the auger to prevent overfilling of the grain truck based on the monitored grain level and grain fill rate.

In Example 5, the grain unloading monitoring system of claim 3, wherein the system is configured to shut the gate to prevent overfilling of the grain container based on the monitored grain level and grain fill rate.

In Example 6, the grain unloading monitoring system of claim 2, wherein the system is configured to urge the grain cart or grain container fore or aft to distribute unloaded grain and prevent overfilling of the grain container based on the monitored grain level and grain fill rate.

In Example 7, the grain unloading monitoring system of claim 1, wherein the monitored grain level is monitored using a closed-loop control system.

In Example 8, the grain unloading monitoring system of claim 7, wherein the closed-loop control system uses a proportional gain response and an integral gain response to monitor the monitored grain level.

In Example 9, the grain unloading monitoring system of claim 1, wherein the grain fill rate is determined from a response calibration table.

In Example 10, the grain unloading monitoring system of claim 1, further comprising a sensor array configured to maintain distance between the grain container and grain cart.

In Example 11, the grain unloading monitoring system of claim 1, further comprising one or more reflectors positioned on a side wall of the grain container.

In Example 12, grain unloading monitoring system comprising, at least one sensor configured to monitor a grain level within a grain container, and a command module configured to command one or more components on a grain cart or grain container to distribute unloaded grain and prevent overfilling of the grain truck based on the monitored grain level.

In Example 13, the grain unloading monitoring system of claim 12, further comprising a processor in electronic communication with one or more flow sensors, the one or more flow sensors configured to determine a grain fill rate.

In Example 14, the grain unloading monitoring system of claim 13, wherein the one or more components comprise an auger and a gate.

In Example 15, the grain unloading monitoring system of claim 14, wherein the system is configured to slow the auger to prevent overfilling of the grain truck based on the monitored grain level and grain fill rate.

In Example 16, the grain unloading monitoring system of claim 14, wherein the system is configured to shut the gate to prevent overfilling of the grain container based on the monitored grain level and grain fill rate.

In Example 17, the grain unloading monitoring system of claim 13, wherein the system is configured to pull the grain cart or grain container ahead to distribute unloaded grain and prevent overfilling of the grain container based on the monitored grain level and grain fill rate.

In Example 18, a grain unloading monitoring system comprising, at least one sensor configured to monitor a grain level within a grain container, and a command module configured to command one or more components on a grain cart or grain container to distribute unloaded grain and prevent overfilling of the grain container based on the monitored grain level and a grain fill level model.

In Example 19, the grain unloading monitoring system of claim 18, further comprising a processor in electronic communication with one or more flow sensors, the one or more flow sensors configured to determine a grain fill rate.

In Example 20, the grain unloading monitoring system of claim 19, wherein the monitored grain level is monitored using a closed-loop control system, wherein the closed-loop control system uses a proportional gain response, an integral gain response to monitor the monitored grain level, and grain flow rate model.

The following terms are used herein with the following meanings.

As used herein, “grain edge” can refer to the point where the edge of the grain pile meets the grain container sidewall surface.

As used herein, “grain edge rise rate” can refer to the change in grain edge distance over time—the distance being the length between the grain edge and the top of the sidewall.

As used herein, grain edge “intercept distance” can refer to the calculated distance from the current grain edge to the top of the sidewall minus a pre-defined offset. This also applies for grain top to tarp support, and is alternately referred to as the “remaining fill height”.

As used herein, grain edge “intercept time” can refer to the calculated time that the current grain edge will reach the top of the sidewall (or tarp support) minus a pre-defined offset. The grain top to tarp support intercept time will be considered a grain edge intercept time. There will typically be three grain edge intercept times measured (left, top, and right)

As used herein, grain cart “unload gate current position” can refer to the current opening distance for grain cart gate.

As used herein, grain cart “unload gate max position” can refer to the max opening distance for grain cart gate.

As used herein, grain cart “unload gate close time” can refer to the time needed to close the grain cart gate from its current position (based on grain cart unload gate close rate).

As used herein, grain cart “unload auger time” can refer to the time needed to unload the grain cart auger after the grain cart unload gate has been closed.

As used herein, grain cart “unload stop time” can refer to the combined time to both close the unload gate and empty the unload auger of the grain cart.

As used herein, “grain cart “scale” refers to the device that measures total grain weight in grain cart container.

As used herein, a grain cart “dispensing rate” can refer to the estimated amount of grain dispensed per unit of time (e.g. Lbs./sec.) into truck as measured by grain cart scales.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF DRAWINGS

FIG. 1A is a diagram of a grain truck, such as exists in the prior art.

FIG. 1B is a diagram of a grain truck with a tarp, such as exists in the prior art.

FIG. 2 is a diagram of a grain truck shown from above, such as exists in the prior art.

FIG. 3 is a diagram of a grain truck and grain cart, viewed from the front, as would be seen during unloading, such as exists in the prior art.

FIG. 4 is a diagram of a grain truck and grain cart, viewed from the side, as would be seen during unloading, such as exists in the prior art.

FIG. 5 is a diagram of a grain truck after being filled, viewed from the side, as would be seen during unloading, such as exists in the prior art

FIG. 6 is a diagram of a grain truck and grain cart using the system with the sensor array on the sides of the spout to optimize grain truck filling viewed from the side, according to one implementation.

FIG. 7 is a diagram of a grain truck and grain cart using the system with the sensor array on the sides of the spout to optimize grain truck filling viewed from the top, according to one implementation.

FIG. 8A is a diagram of a grain truck and grain cart using the system with the sensor array on the sides of the spout to optimize grain truck filling viewed from the front, according to one implementation.

FIG. 8B is a system diagram, according to one implementation.

FIG. 9 is a diagram of a grain truck and grain cart using the system with the sensor array on the end of the spout to optimize grain truck filling viewed from the top, according to one implementation.

FIG. 10 is a diagram of a grain truck and grain cart using the system with the sensor array on the end of the spout to optimize grain truck filling viewed from the front, according to one implementation.

FIG. 11A is a diagram of a grain truck and grain cart using the system with a downward position sensor to optimize grain truck filling viewed from the front, according to one implementation.

FIG. 11B is a diagram of a grain truck and grain cart using the system with an outward position sensor to optimize grain truck filling viewed from the front, according to one implementation.

FIG. 11C is a diagram of a grain truck and grain cart using the system with a default position sensor to optimize grain truck filling viewed from the front, according to one implementation.

FIG. 11D is a diagram of a grain truck and grain cart using the system with a lowered position sensor to optimize grain truck filling viewed from the front, according to one implementation.

FIG. 12 is a flowchart showing the dynamic spout angle adjustment during unload, according to one implementation.

FIG. 13 is a flowchart showing the execution of a pre-defined control command based on the remaining fill height, according to one implementation.

FIG. 14 is a flowchart showing a closed-loop control system for unloading, according to one implementation.

FIG. 15 is a flowchart showing a closed-loop control system for unloading with using measured grain flow rate, according to one implementation.

FIG. 16 is a flowchart showing a feed-forward control system for unloading, the system using measured grain flow rate and grain fill level model, according to one implementation.

FIG. 17 is a flowchart showing a feed-forward control system to cascaded fill height, the system using measured grain flow rate, grain fill level model, and grain flow rate model, according to one implementation.

FIG. 18 is a flowchart showing the inputs of the feedforward control model, according to one implementation.

FIG. 19 is a flowchart showing the threshold activation for system control, according to one implementation.

FIG. 20. is a flowchart showing possible control actions based on the magnitude of change required, according to one implementation.

FIG. 21 is a flowchart showing staged control actions based on the magnitude of change required, according to one implementation.

FIG. 22 is a flowchart the possible grain cart control logic, according to one implementation.

### DETAILED DESCRIPTION

Disclosed herein are various sensors and related systems and methods configured to provide feedback on the position and status of various components involved in the unloading of grain from a grain cart to a grain container, such as via an auger. In various implementations, the grain container can be a grain truck, and the terms will be used interchangeably throughout this disclosure. However, the grain container can also be other grain storage devices, such as but not limited to gravity wagons and the like. Various implementations are used in conjunction with autonomous or assisted-steer tractors, such that an autonomous controller can verify conditions before taking or continuing an action, as would be appreciated. As would be understood, autonomous controllers require feedback from sensors because there is no resident operator to visually check on machine status/performance. Alternatively, if an operator is present an autonomous controller/feedback system can free the operator to focus on other concerns without interruption from needing to monitor the various components of the machine as described herein.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed can 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed can 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed can 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed can 13, 2024, entitled “Devices, Systems, and Methods for Providing Yield Maps,” U.S. patent application Ser. No. 18/665,305, filed can 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/776,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems, and Methods,” U.S. patent application Ser. No. 18/980,728, filed Dec. 13, 2024, entitled “Deck Plate Spacing Sensors and Related Devices, Systems, and Methods,” U.S. Patent Application 63/646,038, filed can 13, 2024, entitled “Seed Tube Camera and Related Devices, Systems, and Methods,” U.S. Patent Application 63/646,068, filed can 13, 2024, entitled “Seed Tube Camera and Related Devices, Systems, and Methods,” U.S. Patent Application 63/651,831, filed can 24, 224, entitled “Non-Contact Methods for Interactions in Navigational Space of Relatively Located Mobile Systems, and Related Devices and Systems,” U.S. Patent Application 63/654,634, filed can 31, 2024, entitled “Equipment Thermal Monitoring System and Associated Methods and Devices,” U.S. Patent Application 63/667,546, filed Jul. 3, 2024, entitled “Cover for Port Openings,” U.S. Patent Application 63/667,530, filed Jul. 3, 2024, entitled “Agricultural Seed Meters and Related Devices, Systems and Methods,” U.S. Patent Application 63/685,000, filed Aug. 20, 2024, entitled “Crop Sensor Wands and Related Devices, Systems, and Methods,” U.S. Patent Application 63/682,229, filed Aug. 12, 2024, entitled “Integrated Crop Sensor and GPS Steering Systems and Related Devices and Methods,” U.S. Patent Application 63/683,149, filed Aug. 14, 2024, entitled “Seed Tube Camera and Related Devices, Systems, and Methods,” U.S. Patent Application 63/710,492, filed Oct. 22, 2024, entitled “Crop Sensors and Related Devices, Systems, and Methods,” U.S. Patent Application 63/710,641, filed Oct. 23, 2024, entitled “Agricultural Sprayer Boom Flush, Chemical Detection and Chemical Concentration Detection,” U.S. Patent Application 63/720,611, filed Nov. 14, 2024, entitled “Liquid Product Distribution for See and Spray Systems,” U.S. Patent Application 63/722,916, filed Nov. 20, 2024, entitled “Agricultural Harvesting Systems and Related Devices and Methods,” U.S. Patent Application 63/722,934, filed Nov. 20, 2024, entitled “Sprayer PWM Nozzle Valve Pressure Drop Mitigation,” U.S. Patent Application 63/723,400, filed Nov. 21, 2024, entitled “Systems, Methods and Devices for Increasing Machine Operating Range Using PWM and Dynamic Pressure Range Control,” U.S. Patent Application 63/723,436, filed Nov. 21, 2024, entitled “Seed Tube Camera and Related Devices, Systems, and Methods,” and U.S. Patent Applicant 63/727,579, filed Dec. 3, 2024, entitled “Smart Shift System for Automatic AB Line Adjustment in Agricultural Operations and Related Devices and Methods,” each of which is incorporated herein by reference.

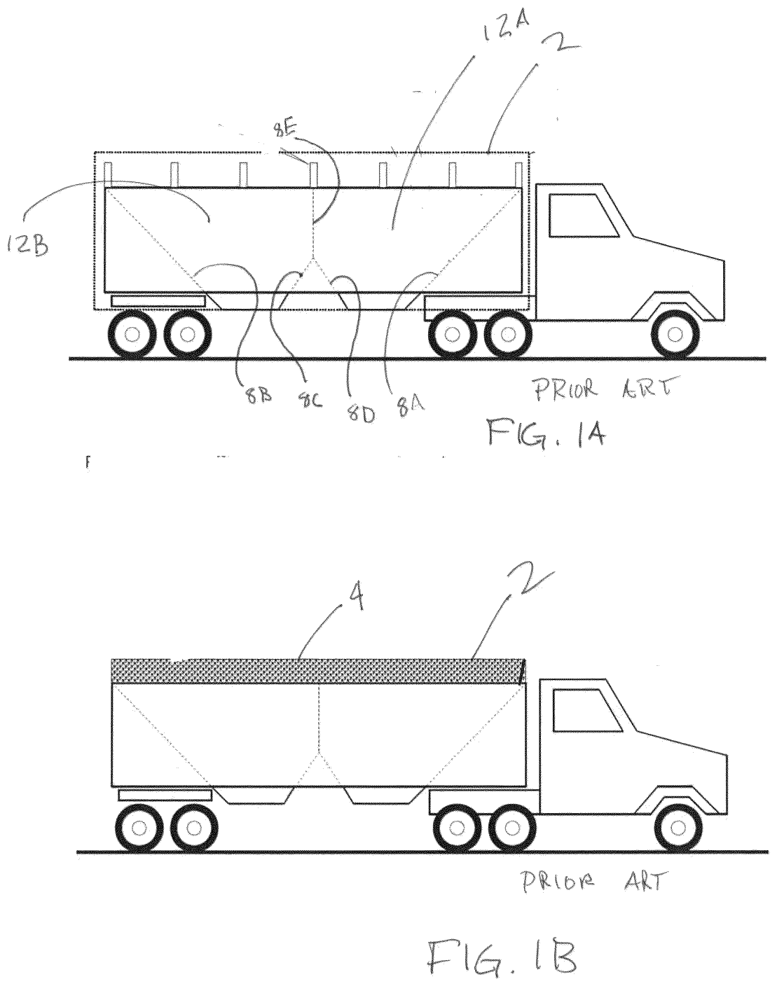

Turning to the drawings of the system 10 in greater detail, according to certain implementations in greater detail, FIGS. 1A-1B depict side views of a typical prior art grain truck 2 having a tarp 4 supported by one or more supports 6 as well as interior container walls 8A, 8B, 8C, 8D, 8E enclosing interior container(s) 12A, 12B, as would be well understood.

FIG. 2 depicts a top view of another such grain truck 2, showing the various walls, namely the front endwall 14A, the left sidewall 14B, the right sidewall 14C, and the back endwall 14D, and the tarp supports 6 disposed above the containers 12A, 12B.

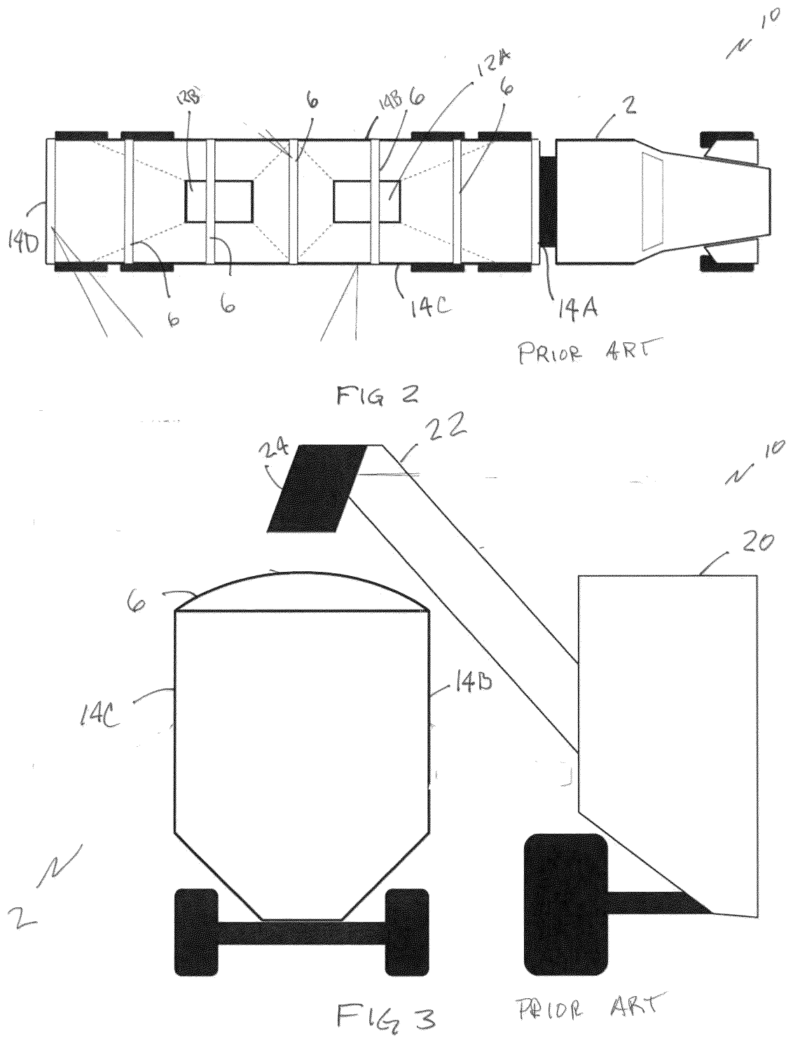

FIG. 3 depicts the grain truck 2 adjacent to a grain cart 20 for an unloading operation, as would be understood. In such implementations, the grain is unloaded from the cart via an unload auger tube 22 and spout 24.

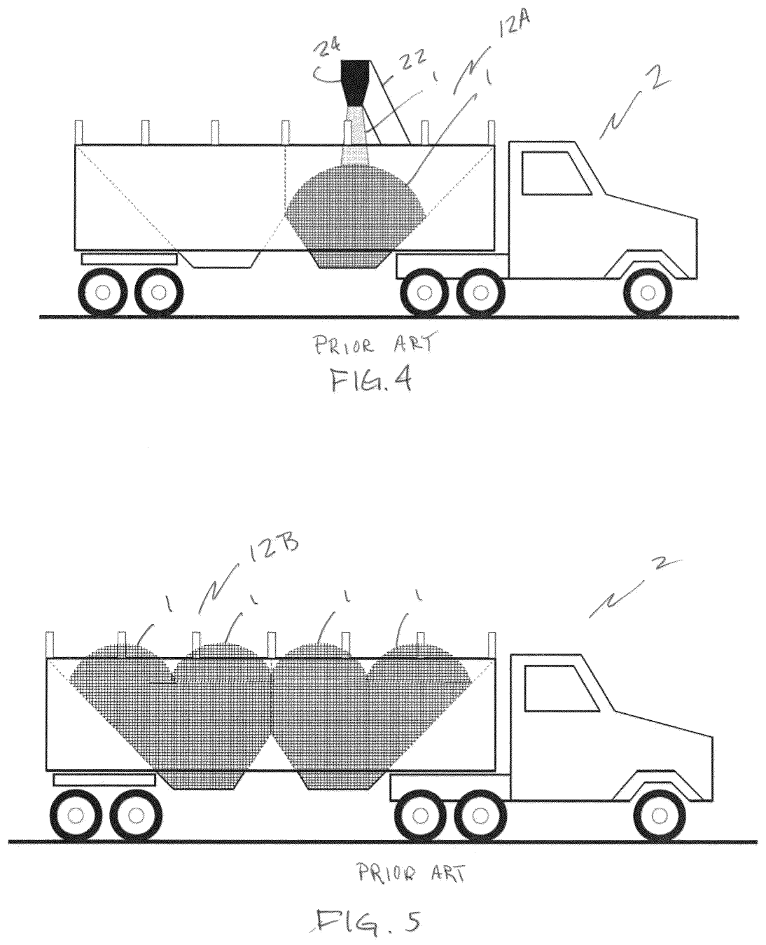

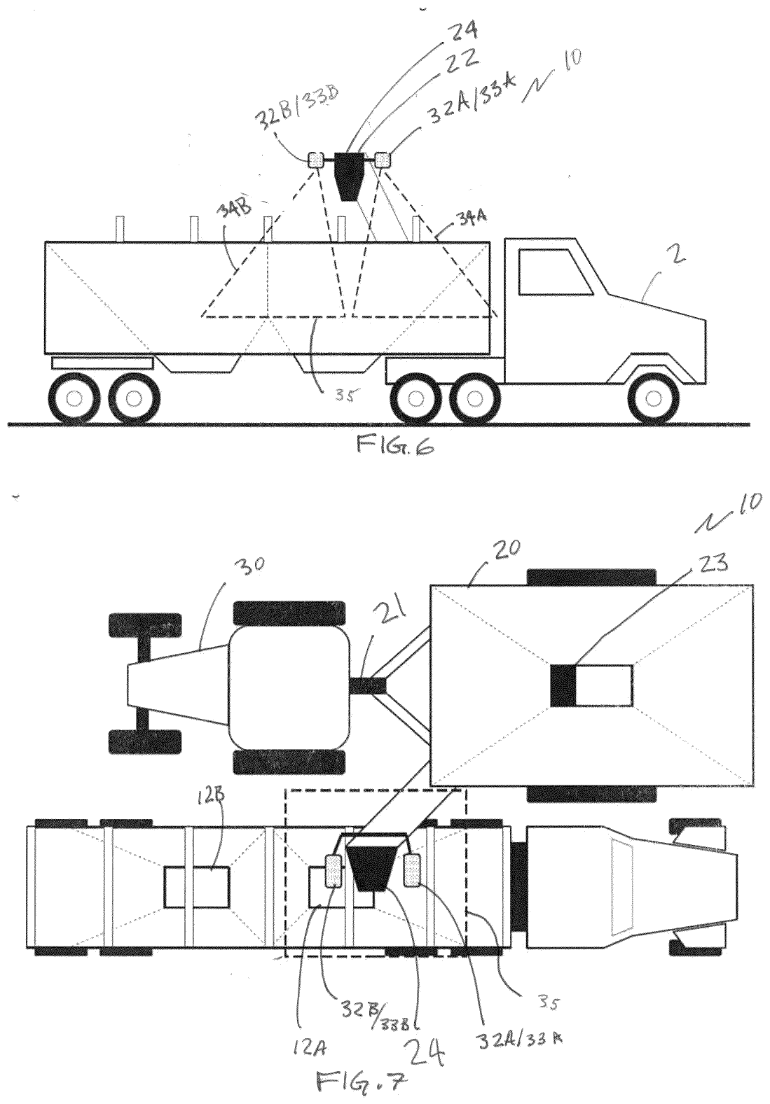

As is shown in FIG. 4, the grain 1 can be dispersed via the spout 24 into the first interior container 12A, and then second interior container 12B until the grain truck 2 is full of grain 1, as is shown in FIG. 5.

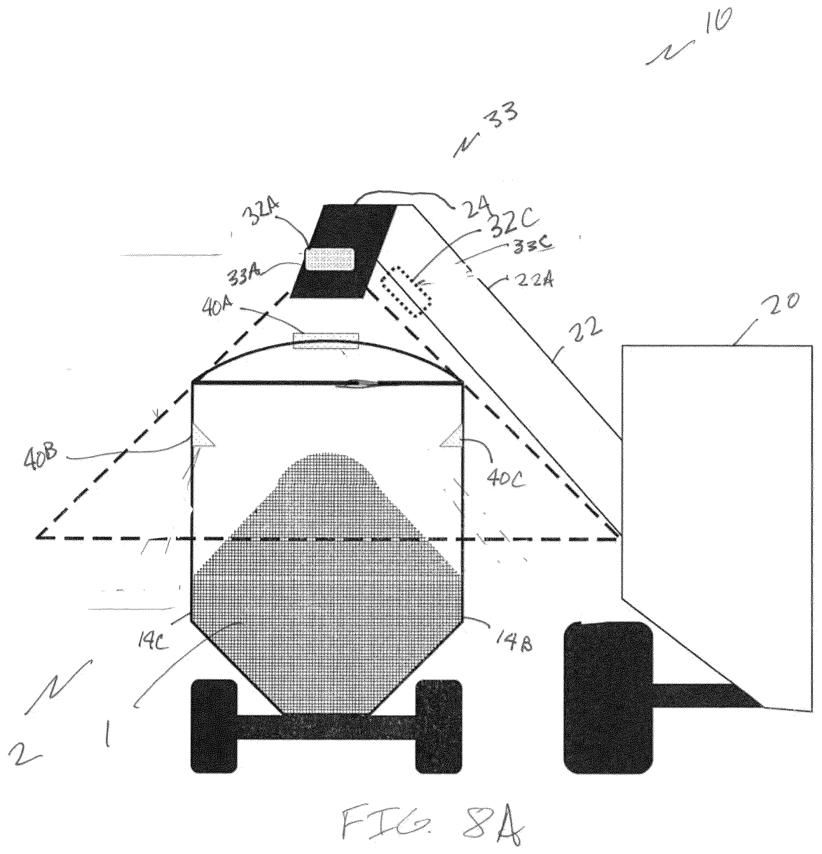

As shown in the implementation of FIG. 6, to address the challenges with unloading grain 1 from grain cart 20 to grain truck 2, the sensor and control system 10 is configured to monitor, in certain implementations, the grain fill in the truck 2 and then control elements in the tractor that actuate the grain cart 20 components used for unloading, such as but not limited to: the power-takeoff shaft 21 used for unloading auger 22 speed control; controllable hydraulic valve for unload gate 23 position control; controllable hydraulic valve for unload spout 24 angle control; controllable hydraulic valve for unload auger 22 angle control and others.

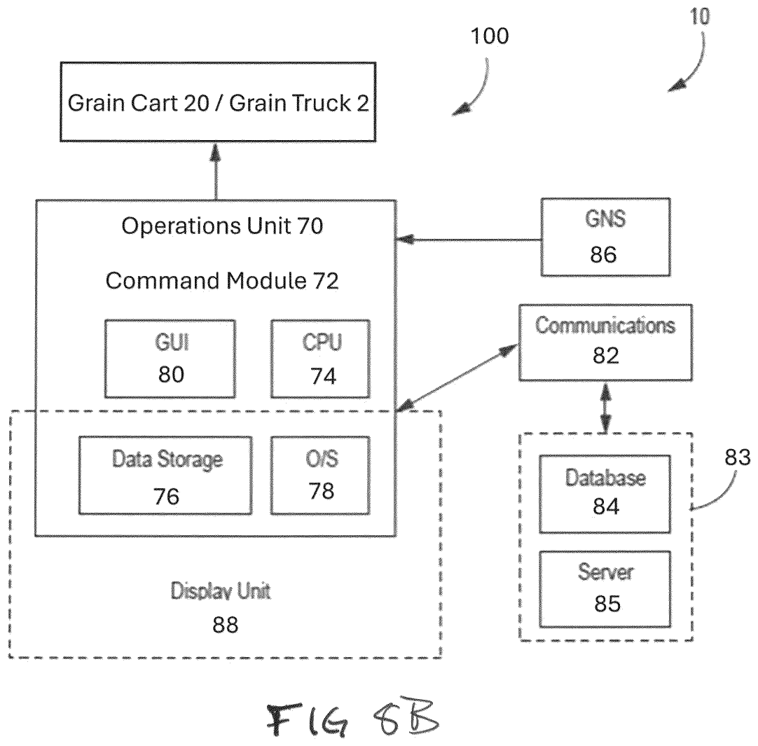

In addition to controlling the grain cart 20 components, the unload auger 22 and spout 24, the control system 10 according to certain implementations can, in certain implementations, control the forward motion/steering of the grain cart 20 tractor 30 (shown FIG. 7) so that the relative position of the grain cart 20 can be varied fore or aft relative to the grain truck 2 during unloading, as is described further herein.

In certain alternate implementations, the system 10 can not directly control the tractor elements or forward motion, but instead issues alerts or cues to the grain cart 20 tractor operator to control the elements through visual and audible approaches, or manually, as described in detail here.

### Sensor and Mounting

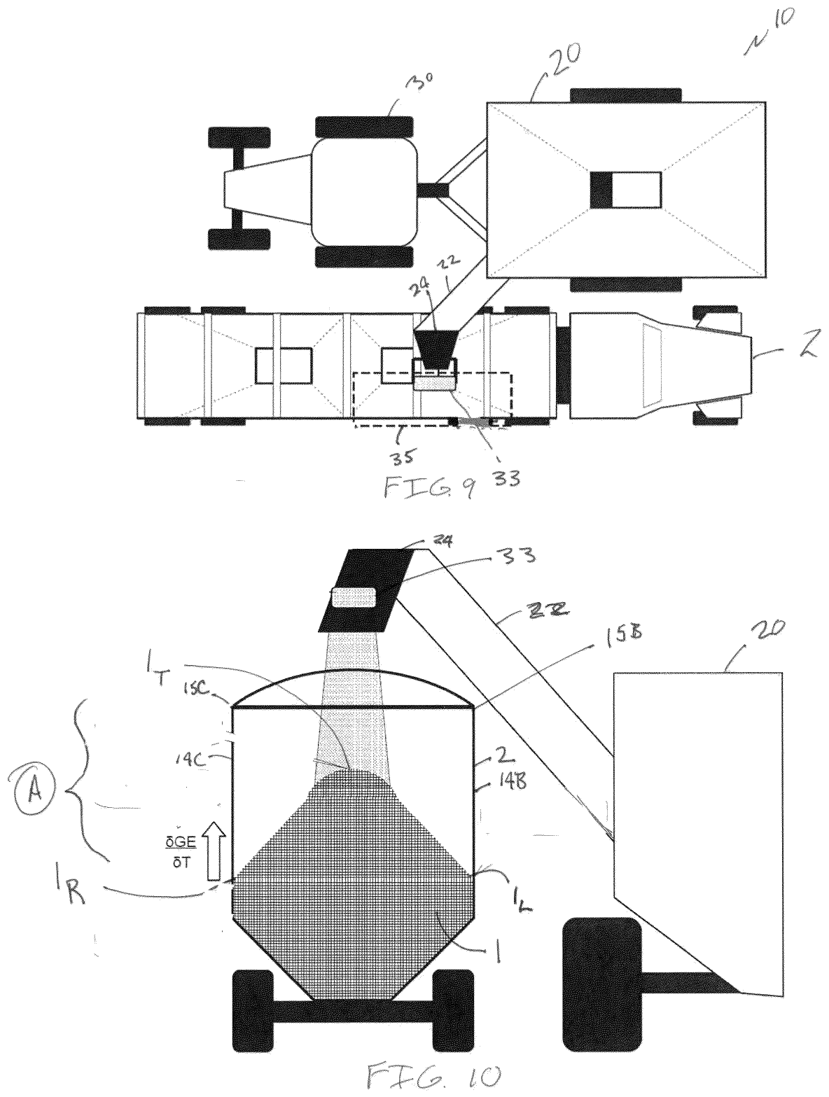

As shown, for example, in FIGS. 6-8, in multiple implementations of the system, at least one sensor 32 is positioned at the end of the grain cart 20 unload auger 22, optionally on the unload spout 24. As shown in the implementations of FIGS. 6-8, a plurality of sensors 32A, 32B or sensor arrays 33A, 32B can be utilized, each optionally having a distinct field of view (“FoV”) 34A, 34B, as would be understood, and it is further understood that in such implementations, the system 10 has an aggregate FoV 35. Further, the placement of the sensor arrays 33A, 33B can be selected for a grain cart 20 mounted sensor because it is positioned above the truck 2 during unload and has a direct view into the truck container(s) 12A, 12B. A potential challenge with this mounting location is that the grain 1 being unloaded can obstruct the FOV 34A of a given individual sensor 32A FoV 34A of the piling grain 1. Swirling grain dust from dispensing grain can also obstruct the FoV 34A. Therefore, in some implementations, the sensor 32A can be a sensor array 33A and include sensor elements on multiple sides of the unload spout 24 so the grain 1 can be adequately sensed and measured to maximize the aggregate FoV 35, as would be understood. Further placements and variations are of course understood, such as shown in FIG. 8A.

In various implementations, the sensor 32 or sensor array 33 is optionally made up of one or more distance measuring sensors with a FoV 34 in a downward direction (looking into the grain truck 2 trailer containers 12A, 12B). This allows the one or more sensors 32 or sensor arrays 33 to measure the distance to the grain 1 in the grain truck 2 trailer. Certain non-limiting examples of the sensor array(s) 33 include one or multiple sensor 32 types including: Lidar, Radar, Optical Time-of-Flight (“ToF”), Ultrasonic, Mono Camera, Stereo Cameras, Mono Camera with Structured Light. A sensor array 33 can also include one or multiple instances of one or multiple sensor types, as would be understood. Further examples are of course readily appreciated.

Continuing with the implementation of FIG. 8A, the unload auger 22 (tube) is an alternative location for mounting the sensor array 33C (or one of the sensors 32C of the array—that is, an implementation can comprise an array 33 having a sensor 32A mounted adjacent to the spout 24 and another sensor 32C mounted on the side of the auger 22). In further implementations, a single sensor 32C or sensor array 33C can be mounted to the side of the auger 22 exclusively, or a single sensor 32A or sensor array 33A can be mounted to the side of the auger 22 exclusively, and the like. Further mounting positions above the sides 14B, 14C of the grain truck 2 are of course also possible. It is understood that when positioned for unloading into the truck 2, the upper portion 22A of the unload auger 22 also has a view into the containers 12A, 12B during unloading. Mounting sensors 32 on the side or bottom of the upper part of the unload auger tube will also allow the grain 1 in the trailer to be sensed and measured.

The system 10 according to certain implementations can also include the placement of optical or radar reflectors 40A, 40B, 40C on the trailer tarp supports 6 and/or along the trailer sidewalls, respectively, as well as elsewhere. Certain non-limiting examples of such reflectors 40 are optical reflectors, reflective tape, reflective paint, or radar corner reflectors. One purpose of the reflectors 40 is to provide the system 10 with a strong reflective location on a key element that establishes the relative positioning of the sensor array (on the grain cart 20 unload spout 24) and the grain truck 2 trailer, as would be understood.

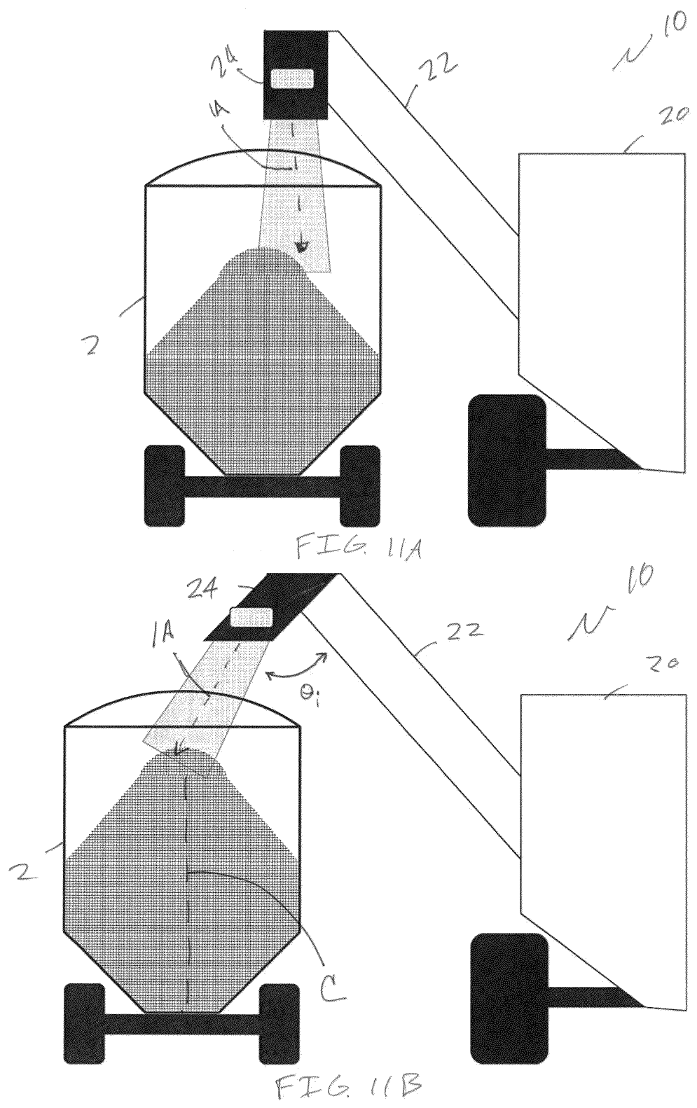

In another implementation illustrated in FIGS. 8A-9, a sensor array 33 is mounted on the end of the unload spout 24 with a limited field-of-view into the truck container. In this implementation, the system 10 utilizes an operations unit 70 in operational communication with the grain cart 20 and/or grain truck 2, a communications component 82, and/or GNSS 86. In certain of these implementations, the operations system 102 is wholly or partially housed in an in-cab display 88, or otherwise in operational communication therewith though the various components described herein can be housed elsewhere, as has been previously described and would be readily appreciated.

In certain implementations, the operations unit 70 has several optional components. In one exemplary implementation shown in FIG. 8B, the operations unit 70 comprises a command module 72 and they are configured to execute the various commands and issue electronic communications to the various components to effectuate the steps contemplated by the various methods of operation 100 described herein.

The operations unit 70 according to certain implementations has one or more optional processing and computing components, such as a CPU/processor 74, data storage 76, operating system 78, graphical user interface (GUI) 80, and other computing components necessary for implementing the various technologies disclosed herein. It is appreciated that the various optional system components are in operational communication with one another via wired or wireless connections and are configured to perform the processes and execute the commands described herein.

In certain implementations, like that of FIG. 8B, the communications component 82 is configured for the sending and receiving of data for cloud 83 storage and processing, such as to a remote server 84, database 85, and/or other cloud computing components readily understood in the art. Such connections by the communications component 82 can be made wirelessly via understood internet and/or cellular technologies such as Bluetooth, WiFi, LTE, 3G, 4G, or 5G connections and the like. It is understood that in certain implementations, the communications component 82 and/or cloud 83 components comprise encryption or other data privacy components such as hardware, software, and/or firmware security aspects. In various implementations, the operator or enterprise manager or other third parties are able to receive notifications via their mobile phones or other devices.

The various sensors 32 and sensor arrays 33, according to certain implementations, are configured to electronically report the data it collects to the operations unit 70. Along with the machine operator, other electronic modules and devices would be able to access this data and use it for their calculations, algorithms, programs, etc. Optionally, the recorded data is logged and stored in data storage, either in the operations unit 70 or on the cloud 83. Further, the data can include or be associated with GNS 86 data for spatially logging and visualizing the data.

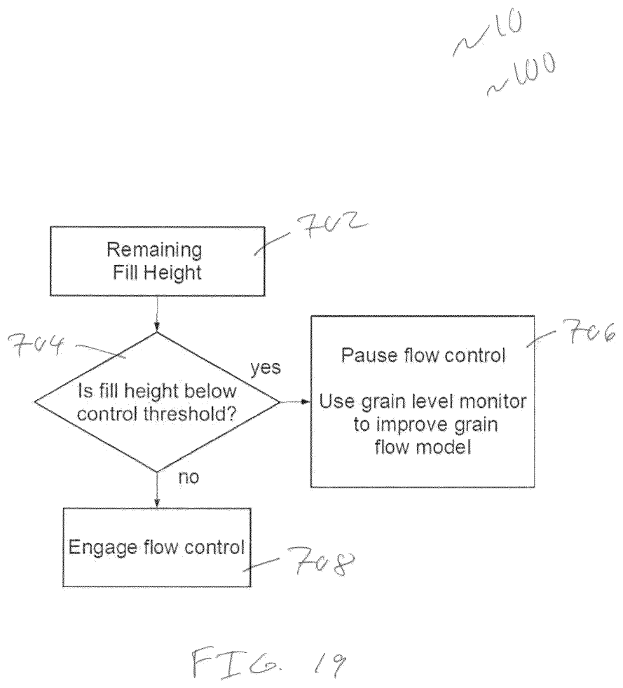

In various implementations, the operations system 70 receives the raw sensor 32 or sensor array 33 data, as well as the other optional data discussed herein, then runs it through an algorithm that is calibrated to the sensor 32, sensor array 33 or other data sources described herein, such as for example in FIG. 18.

Various implementations of the system 10 are thereby configured to model the height of the piling grain based on the state of the grain pile that is visible to the sensor array 33. The model can utilize sensor readings taken before grain starts to dispense. For example, readings can be taken when the grain cart 20 moves into position to unload into the truck. In this state, the FOV 35 is not obstructed by dispensing grain or grain dust.

As shown in FIG. 10, and as discussed further herein, the sensor array 33 can be able to obtain reliable readings for left 1_{L} and right 1_{R} grain edge and grain edge intercept distances for left and right sidewalls and tarp support. This can provide accurate starting values for the model before grain 1 and grain dust start to obstruct the sensor view. The modeling of the grain pile can also optionally use the additional following non-limiting examples of data. From the grain cart: grain cart scale weight, grain cart unload auger rotational speed, grain cart unload gate open distance and the like. From the combine: grain (crop) type, grain moisture and the like. These are of course exemplary implementations and not intended to limit the variety of data that is possible.

### Grain Fill Monitoring

One function of the sensor array 33 for the grain cart 20 fill monitoring algorithm is to measure and/or model the distance from the grain pile side wall edge (hereafter referred to as “grain edge,” left 1_{L} and right 1_{R} grain edges and top grain edge 11 shown in FIG. 10) to the top of the side wall, shown in FIG. 10 at 15B and 15C for the left 14B and right 14C sidewalls, respectively. In addition to measuring the grain edge-to-sidewall distances (shown generally relative to the right sidewall 14C at Bracket A), the system 10 according to certain implementations measures the change in those distances over time. This is the grain edge rise rate for each of the left 1_{L} and right 1_{R} grain edges, given as:

$$R = \frac{δ GE}{δ T}$$

wherein GE is the grain edge and T is time. Sensing and calculating the grain edge rise rate R for a given grain edge allows the system 10 to estimate the time until a given grain edge 1_{R} will meet the top 15C of the relevant side wall 14C (when grain will start to spill over the side wall 15C of the truck trailer). It is appreciated that the time to reach each top 15B, 15C can not be the same, and as such the system 10 can be configured to stop when the earlier of the right top 15C or left top 15B is reached, as would be readily understood.

In addition to the left 1_{L} and right 1_{R} grain edges, the system 10 can also be configured also prevent the top edge 11 of the grain pile from surpassing the tarp supports 6. If the top edge 11 of the grain pile 1 is above the tarp supports 6, it is not possible to properly deploy the tarp to cover the grain during transport. Thus, the system 10 can be configured to measure the rise rate of the top edge 1 of the grain pile as well, similar to that described above, and stop the flow of grain accordingly.

As would be understood, the grain cart 20 (and unload spout 24) and grain truck 2 move independently, so the distance from the grain cart 20 unload spout 24 (sensor array) to the grain truck 2 will be different during every unload and can change during an unload, depending on relative location. This will happen any time the grain cart 20 and grain truck 2 are positioned on uneven terrain, which can be quite often. The independent movement of the grain cart 20 and grain truck 2 can refer to that the grain fill monitoring system needs to be able to detect, identify, and measure the distance to one or more known, fixed locations on the truck container. The distance from the sensor array to these fixed locations provides a distance-measuring anchor that allows the system to then measure grain height based on the top of the sidewalls or the tarp supports. In certain implementations, the fixed location(s) are the top of the tarp supports. However, other locations like the top of the sidewalls can also be used. The operating constraints of the grain truck 2 can be that it should always park on level (or near level) ground. In this case, the truck container is assumed to be level and the height of the container sidewalls can be based on a single anchor position. The system can also use multiple anchor positions along the span of the container so that it can continually update the relative position/distance to the container and more accurately measure the grain edge distances.

When the relative vertical distance between grain cart 20 (unload auger) and grain truck 2 (container) is known, the system then attempts to detect and measure the distance to the grain edge(s) and grain top. As grain is unloaded into the grain trailer, the grain edge-to-sidewall distance and grain top-to-tarp support distance are calculated at a constant rate (e.g., 5 Hz), which allows the grain edge rise rates to be calculated along with the grain edge intercept times. The distance to the grain edge can not be measured directly but instead modeled based on input from the sensor array measurements as well as other sensor inputs in the system.

The system can use the grain cart 20 scale to determine the actual grain dispensing rate (e.g. in units of lbs/sec). The system receives the total grain weight at 1-5 Hz update rate from the grain cart 20 scale as the grain is unloaded. The system can calculate the grain dispensing rate by subtracting the current total weight from the prior total weight. Divide by the time span to get the dispensing rate. The system can use the dispensing rate as an input into the model that determines distance to the grain edge.

It is not expected that the grain edges should or will meet the top of the sidewalls (or tarp support) exactly. There will be an offset distance used so that small inaccuracies within the measuring and modeling system will not result in grain spillage. The offset distances can be a fixed distance or an operator-configurable setting.

It is difficult to detect and measure the exact top of the pile (top grain edge) because the unloading grain is usually contacting the top of the grain pile. Therefore, the distance to the grain pile top can be modeled based on distance data the sensor array collects from the more visible (i.e. accessible) regions of the growing grain pile.

The system 10 can provide a “live” truck container fill level graphic to the grain cart 20 operator as the truck fills. FIGS. 4, 5 and 10 are visualization examples that a grain cart 20 operator can watch as the truck fills. The visualizations can help the operator know when to move the grain cart 20 to avoid spillage or overfill.

### Grain Cart to Grain Truck Alignment

In various implementations, the sensor array field-of-view allows the sidewalls of the grain trailer to be detected and measured. Measuring the distance to one or more of the sidewalls allows the system to determine the position of the unload auger and unload spout relative to the grain trailer. For a grain cart with no adjustable elements, the system can inform the grain cart operator on alignment and/or alert the grain cart operator of misalignment and the need to re-approach the truck to get the alignment within the acceptable range.

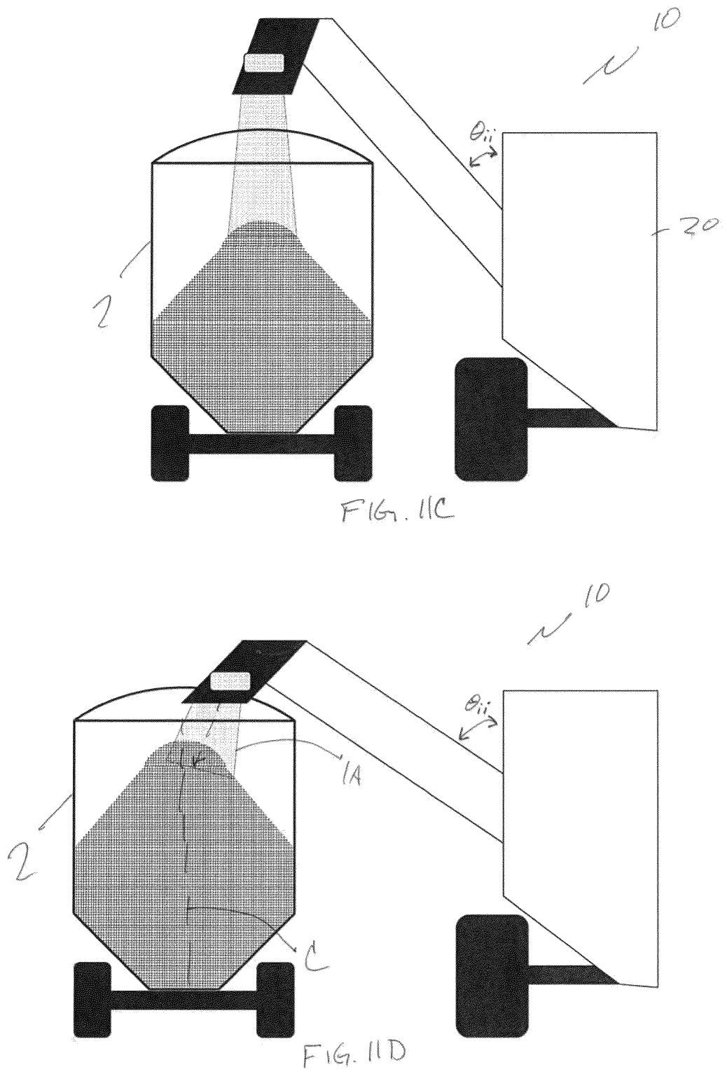

For some grain carts, the angle of the unload spout is controllable within a range. FIGS. 11A-11B demonstrate the movable unload spout 24A. As shown in FIG. 11B, the adjustable unload spout 24A enables the operator to angle θᵢ the unloading stream of grain (dashed line 1A) to the center C of the grain truck 2 trailer if the lateral positioning between grain cart and grain truck is misaligned (default unload stream not aligned to lateral center of trailer). With the relative position measured between the unload spout 24 and the grain truck 2 trailer, the system 10 can either automatically control the unload spout 24 angle θᵢ or direct the operator to control the unload spout to the correct position, as would be understood.

Some grain carts also have angle control on the complete unload auger 22 as shown in FIGS. 11C-11D. Here again, the system 10 is configured to measure the relative position between the grain cart 20 unload spout 24 and grain truck 2 trailer, and therefore can control the unload auger 22 angle θᵢᵢ to center the unload spout for optimal unloading of the flowing grain 1A to the lateral center C of the grain truck 2 trailer.

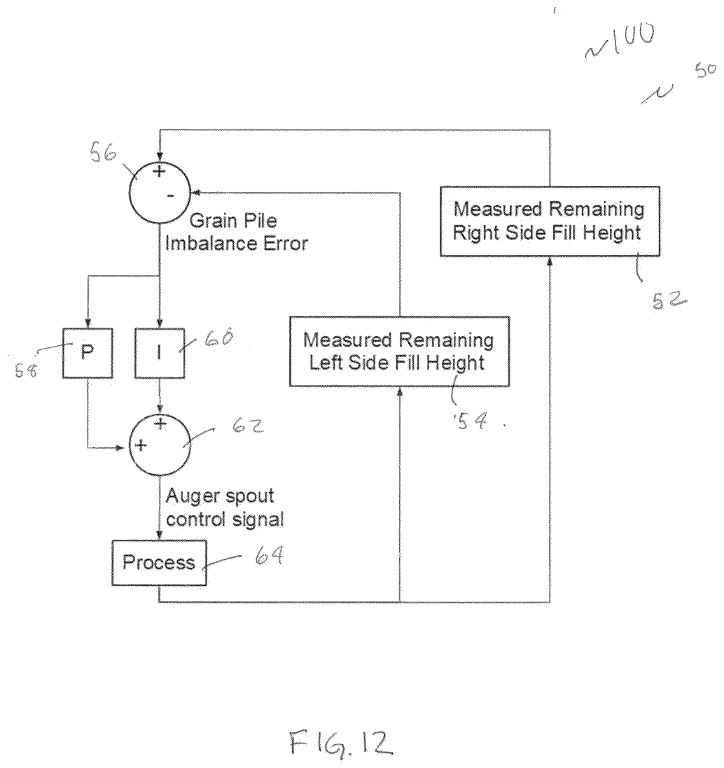

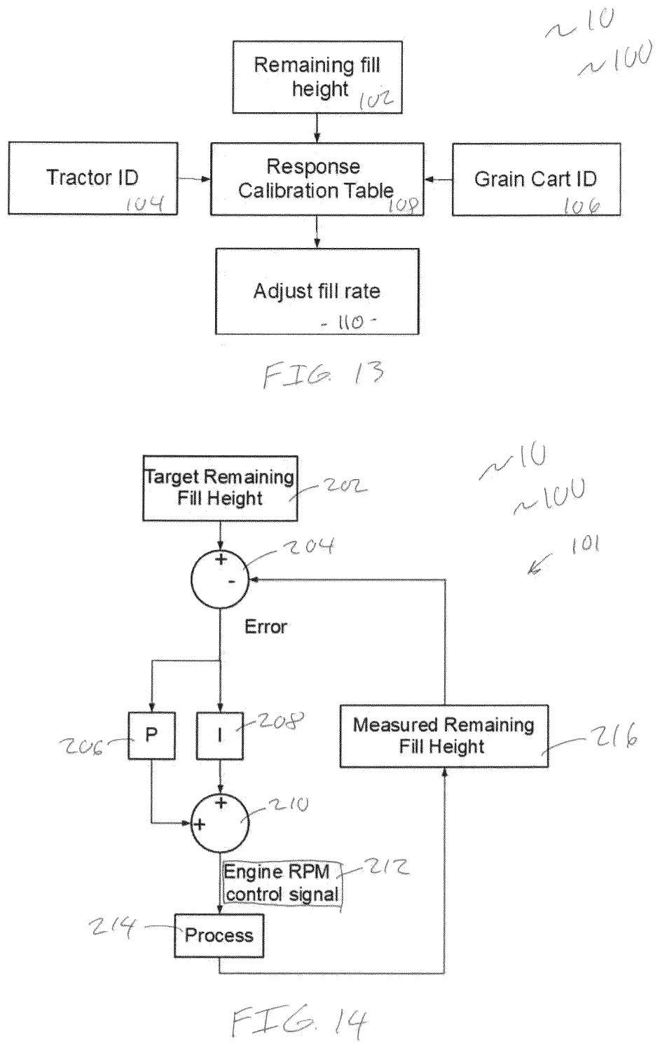

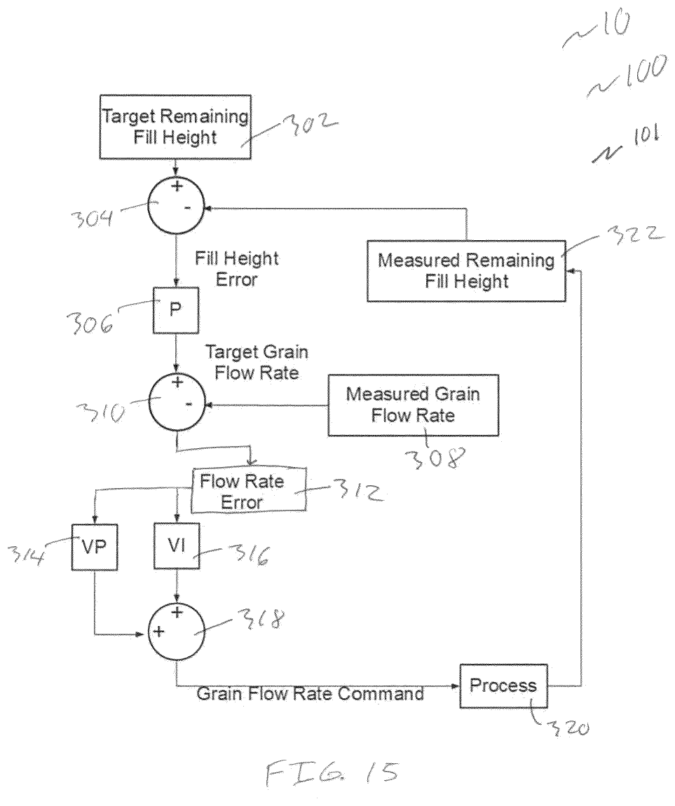

In various implementations, the system 10 can have a dynamic spout angle control algorithm is also proposed, such as is shown in FIG. 12. In such implementations, the adjustment of the spout angle would occur during the unload process and would be based on an imbalance between the left and right grain edge distances. In this diagram, the P is the proportional control gain, and I is the integral control gain. The control spout is used to maintain even loading between trailer sides

In implementations where the system 10 has a dynamic spout angle control algorithm 50, the system 10 can measure both a measured remaining right side fill height (box 52) and a measured remaining left side fill height (box 54). The measured remaining right side fill height and measured remaining left side fill height can be used to calculate a grain pile imbalance error (box 56). The grain pile imbalance error can be used to calculate a proportional response gain “P” (box 58) and an integral response gain “I” (box 60). The proportional response gain and integral response gain can be used to calculate an auger spout control signal (box 62), which can be sent to various process components, such as the spout controller or spout actuator (box 64). The system can then continue to measure a measured remaining right side fill height (box 52) and a measured remaining left side fill height (box 54) and update periodically.

### Grain Fill Control

As would be appreciated, an effective grain fill control system 10 seeks to fill the grain trailer as rapidly as possible while preventing grain spillage outside the truck container and an overfill of grain at or above the tarp support structure. The control system 10 disclosed herein can use any or all grain fill monitoring data to allow effective control. Additionally, the control system can command changes to various tractor and grain cart control elements listed above to adjust the rate or location of the grain flow.

In various implementations, the system 10 defines the remaining fill height as the difference between the grain edge and the top of the trailer sidewall and defines zero remaining fill height is considered full for a centered grain pile.

One such fill control method 100 is shown in FIG. 13, monitors the remaining fill height and uses a pre-defined lookup table to adjust the fill rate. It is understood that the various fill control methods described herein can be executed via the operations unit 70/command module 72/processor 74, as described in the implementation of FIG. 8B.

That is, in these implementations, a lookup table is provided that is based on the calibration of the tractor and grain cart combination, and FIG. 13 depicts the execution of a pre-defined control command via the operations unit 70 based on the remaining fill height, according to certain implementations. In these implementations, the remaining fill height data (box 102) as determined by the system 10 (discussed above) is combined with the Tractor ID value (box 104) and Grain Cart ID value (box 106) data into a response calibration table (box 108) and the system 10 adjusts the fill rate (box 110).

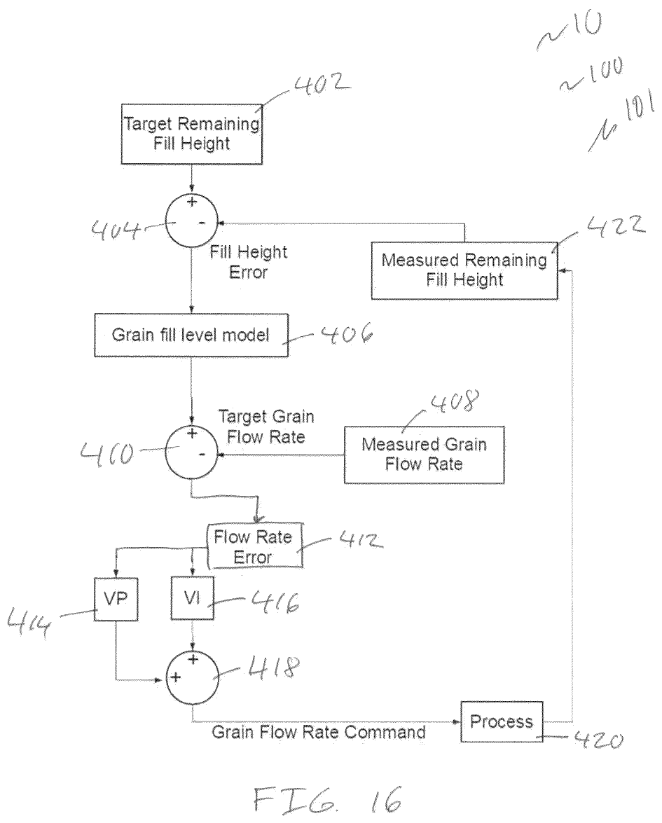

In various implementations, such as shown in FIG. 14, the remaining fill height data (box 202) can be used as feedback for a closed-loop control system 101, such as a Proportional-Integral controller 101. In such implementations, the system 10, in executing an exemplary method 100 of operation, can determine an error based on the target fill height data and the measured remaining fill height (box 204). This error can be used to a calculate proportional response gain “P” (box 206) and an integral response gain “I” (box 208). The proportional response term and integral response term then can be combined (box 210) and used to calculate a new engine RPM control signal (box 212), which can be directed to the relevant process components (box 214), such as a motor or motor controller. The system 10 can then measure a measured remaining mill height (box 216), which can be used to impact subsequent recalculations of the error. In various implementations, the error can respond proportionally to changes in the target remaining fill height and can respond inversely proportionally to changes in the measured remaining fill height. Similarly, in various implementations, the engine RPM control signal can respond proportionally to changes in both or either of the proportional response gain and integral response gain. In these implementations, as would be understood, as the measured remaining fill height decreases, the engine RPM will also decrease, reducing the grain flow.

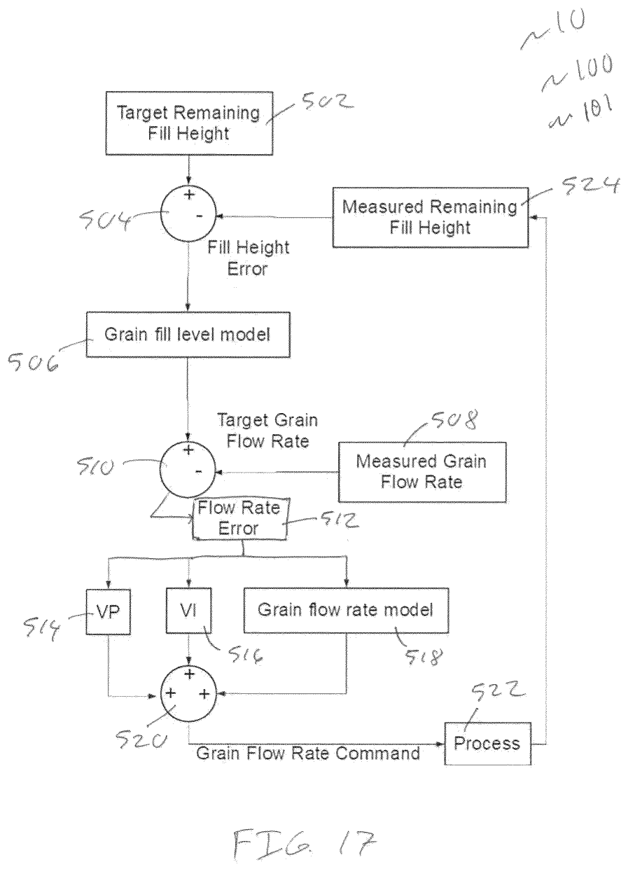

Controlling the grain flow rate as the inner loop of a fill height closed-loop control system 101 can offer the potential of improved accuracy over traditional methods. In various implementations, such as in FIG. 15, grain flow rate can be a function of the grain cart unload gate current position and the tractor engine speed (RPM), which can translate to the grain cart unload auger speed. As shown in FIG. 15, in these implementations, the P is the proportional control gain. The inner control loop controls the grain flow rate, or grain level velocity. VP is the proportional control gain of the grain level velocity loop and VI is the integral control gain of the grain level velocity loop, as will be discussed below.

Some implementations, as shown in FIG. 15, can use a closed-loop control system 101 that is a cascaded closed-loop control system 101 with both fill rate and remaining fill height taken as system 10 inputs. In such implementations, the system 10, in executing an exemplary method 100 of operation, can have a target remaining fill height (box 302), which can be input by a user or calculated from elsewhere in the system 10, such as is described above at FIG. 10. The system 10 according to these implementations can also be configured to determine a fill height error based on the target fill height data and the measured remaining fill height (box 304). The fill height error can be used to a calculate proportional response gain “P” (box 306). The system 10 can intake a measured grain flow rate, optionally obtained through one or more flow sensors in the system 10 (box 308). A target grain flow rate can be calculated from the proportional response gain and the measured grain flow rate (box 310). From the target grain flow rate, the system 10 can calculate a flow rate error (box 312). The flow rate error can be used to then calculate a grain level velocity proportional gain “VP” (box 314) and a grain level velocity integral grain “VI” (box 316). The level velocity proportional gain “VP” and a grain level velocity integral grain “VI” can then be used to calculate a grain flow rate command (box 318), which can be output to various components of the system 10, such as a motor or motor controller (box 320). The system 10 can then measure a measured remaining mill height (box 322), which can be used to impact subsequent recalculations of the error.

Some implementations, such as shown in FIG. 16, can utilize a feed-forward control to a grain flow closed-loop control system 101. In these implementations, the outer loop proportional fill height control can be replaced by a feed-forward grain fill level model as shown in FIG. 16. This model can be a static calibration model or a dynamic simulation based on sensor inputs. The control loop controls the grain flow rate, or grain level velocity. VP is the proportional control gain of the grain level velocity loop and VI is the integral control gain of the grain level velocity loop.

In such implementations, the system 10, in executing an exemplary method 100 of operation with a closed-loop control system 101, can have a target remaining fill height (box 402), which can be input by a user or calculated from elsewhere in the system 10. The system 10 can determine a fill height error based on the target fill height data and the measured remaining fill height (box 404). The fill height error can be input into a grain fill level model (box 406). As discussed above, the model can be a static calibration model or a dynamic simulation based on sensor inputs. The system 10 can intake a measured grain flow rate, optionally obtained through one or more flow sensors in the system 10 (box 408). A target grain flow rate can be calculated from the output of the grain fill level model and the measured grain flow rate (box 410). From the target grain flow rate, the system 10 can calculate a flow rate error (box 412). The flow rate error can be used to then calculate a grain level velocity proportional gain “VP” (box 414) and a grain level velocity integral grain “VI” (box 416). The level velocity proportional gain “VP” and a grain level velocity integral grain “VI” can then be used to calculate a grain flow rate command (box 418), which can be output to various components of the system 10, such as a motor or motor controller (box 420). The system 10 can then measure a measured remaining mill height (box 422), which can be used to impact subsequent recalculations of the error.

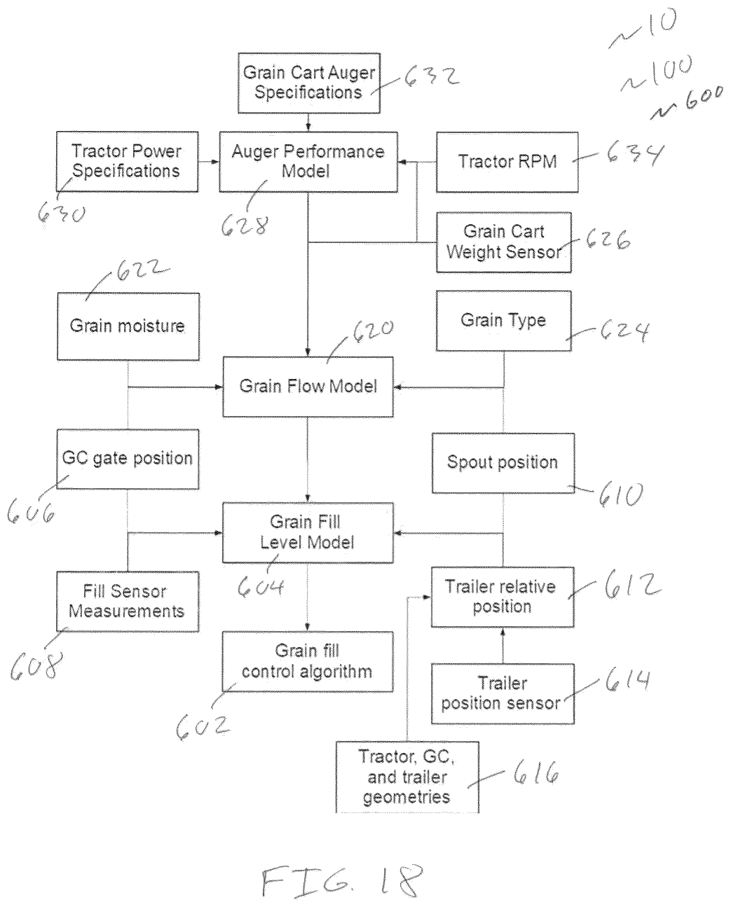

In alternative implementations, a grain flow model can be added to the grain fill level model. This is shown in FIG. 17. As explained previously, both models can be static or dynamic. The control loop controls the grain flow rate, or grain level velocity. VP is the proportional control gain of the grain level velocity loop and VI is the integral control gain of the grain level velocity loop.

In such implementations, the system 10, in executing an exemplary method 100 of operation with a closed-loop control system 101, can have a target remaining fill height (box 502), which can be input by a user or calculated from elsewhere in the system 10. The system 10 can determine a fill height error based on the target fill height data and the measured remaining fill height (box 504). The fill height error can be input into a grain fill level model (box 506). As discussed above, the model can be a static calibration model or a dynamic simulation based on sensor inputs. The system 10 can intake a measured grain flow rate, optionally obtained through one or more flow sensors in the system 10 (box 508). A target grain flow rate can be calculated from the output of the grain fill level model and the measured grain flow rate (box 510). From the target grain flow rate, the system 10 can calculate a flow rate error (box 512). The flow rate error can be used to then calculate a grain level velocity proportional gain “VP” (box 514) and a grain level velocity integral grain “VI” (box 516). The flow rate error can also be used as an input into a grain flow rate model (box 518). As discussed above, the grain flow rate model can be a static calibration model or a dynamic simulation based on sensor inputs.

The level velocity proportional gain “VP” and a grain level velocity integral grain “VI” can then be used to calculate a grain flow rate command (box 520), which can be output to various components of the system 10, such as a motor or motor controller (box 522). The system 10 can then measure a measured remaining mill height (box 524), which can be used to impact subsequent recalculations of the error.

FIG. 18 includes various sensor measurements and calibration data (shown generally at 600) that can be employed in the grain flow model (box 620), grain fill level model (box 604) and grain fill algorithm (box 602) according to various implementations of the system 10. The various feed forward control models can use these values based on one-time calibration or a dynamic state estimation algorithm such as a Kalman filter. It is understood that each of these values drawn from these exemplary sensor measurements and calibration data types are optional and exemplary, and that any or all of these can be included or omitted.

FIG. 18 depicts a hierarchical system of various sensor inputs, setup information, and models that result in an overall grain fill control algorithm. The system 10, in executing an exemplary method 100 of operation, can use various inputs in constructing the grain fill control algorithm (box 602) has as an input the grain fill level model output which it utilizes for actuation of the controllable components (engine RPM, feed gate position, etc.). The grain flow model (box 604) subsequently has inputs which include various optional sensors, settings, and models as shown in FIG. 18.

That is, in various implementations, the grain fill level model (box 604) can optionally utilize input values such as the grain cart (“GC”) gate position (box 606), the fill sensor measurements (box 608), the spout position (box 610), and the trailer relative position (box 612) and thereby the trailer position sensor (box 614) and tractor, GC, and trailer geometries (box 616). The grain fill level model can also be informed by a grain flow model (box 620). In turn, the grain flow model can be informed by some or all of the grain cart gate position (box 606), the spout position (box 610), the grain moisture (box 622), the grain type (box 624), the grain cart weight sensors (box 626), and the auger performance model (box 628), and thereby the tractor power specifications (box 630), the grain cart auger specification (box 632), the tractor RPM (box 634) and the grain cart weight sensors (box 626).

It is understood that the system 10 can implement various machine learning techniques to continuously refine and optimize the control algorithm (602) based on inputs from the array of sensors, user-defined settings, and mathematical models. In one implementation, the system employs supervised learning approaches, wherein historical sensor data paired with optimal control outputs are used to train neural network models. These models can comprise multiple hidden layers with rectified linear unit (ReLU) activation functions, allowing them to learn complex non-linear relationships between the input parameters and desired control responses.

In further implementations, reinforcement learning techniques can be utilized, where the system 10 learns optimal policies through interaction with the environment. Specifically, the system 10 can implement deep Q-learning networks (DQN) or proximal policy optimization (PPO) algorithms to maximize a reward function based on system stability, energy efficiency, and adherence to user-defined constraints. The reward function can be weighted according to user preferences and operational priorities specified through the settings interface.

The system 10, in certain implementations, can also incorporate ensemble methods, combining multiple machine learning models to improve robustness and performance. For example, a random forest regressor can process sensor data to detect anomalous operating conditions, while a gradient boosting classifier determines appropriate control responses based on the current system state and historical performance data. These ensemble approaches enable the system 10 and control algorithm (602) to handle edge cases and maintain reliable operation across diverse operating conditions.

Transfer learning techniques can also be employed by the system 10 to accelerate the training process and improve generalization capabilities. Pre-trained models developed on similar control systems or simulated environments can be fine-tuned using domain-specific data collected from the actual system. This approach significantly reduces the amount of training data required while maintaining high performance levels. Additionally, online learning mechanisms allow the system to continuously adapt to changes in operating conditions or equipment characteristics over time.

The machine learning subsystem implements various regularization techniques to prevent overfitting and ensure robust performance. These include L1 and L2 regularization, dropout layers in neural networks, and cross-validation procedures during model training. The system 10 according to certain implementations also maintains a sliding window of historical data to retrain models periodically, ensuring they remain current with any drift in system behavior or environmental conditions.

FIGS. 19-22 demonstrate aspects of the grain flow rate control and vehicle motion control algorithms that comprise the grain fill control algorithm. In FIG. 19, the system implements a control threshold. Here, flow control is only engaged when the remaining fill height exceeds a set threshold.

In implementations like those of FIG. 19, the system 10, in executing an exemplary method 100 of operation, can intake a remaining fill height (box 702). The system 10 can determine if the remaining fill height is below a control threshold (box 704). If the remaining fill height is below a control threshold, the system 10 can pause flow control and/or use a grain level monitor to a improve grain flow model (box 706). If the remaining fill height is not below a control threshold, the system 10 can engage flow control (box 708).

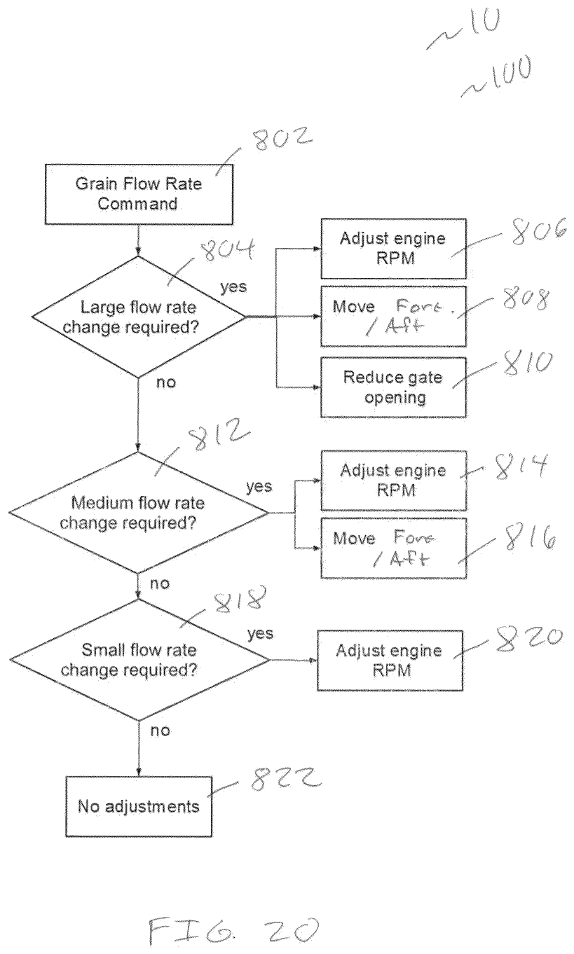

FIG. 20 illustrates a 3-tiered control strategy based on the magnitude of the flow rate change. In implementations using a 3-tiered control strategy, like that of FIG. 20, the system 10, in executing an exemplary method 100 of operation, can receive a grain flow rate command requiring a specific grain flow rate (box 802), such as from a user of the system 10. The system 10 can determine if the required grain flow rate is a large change from the current flow rate (box 804). As would be understood, various methods can be used to determine if a change in flow rate is considered large within the method 100. As an illustrative example, user inputs can be used, but other methods are of course possible. If the required flow rate change is considered large, the system 10 can adjust the engine RPM (box 806), urge the grain cart fore or aft (box 808) relative to the grain container (or vice versa), reduce the gate opening (box 810), or any combination thereof. It is understood that in various implementations, and as also described in FIG. 7, that the system 10 is configured to adjust the relative positioning of the grain cart 20 and grain container 2 relative to one another so as to move either fore or aft relative to the other for optimized alignment of the auger 22 and spout 24, as would be understood.

Continuing with FIG. 20, if the required flow rate change is not considered large, the system 10 can determine whether the change is considered medium (box 812). As would be understood, the threshold for a change to be considered medium would be determined substantially the same way as the thresholds for large changes. If the system 10 determines the required change is medium, the system 10 can adjust the engine RPM (box 814) and/or move the grain cart or container fore or aft (box 816). If the required flow rate is not considered medium, the system 10 can determine whether the change is considered small (box 818). As would be understood, the threshold for a change to be considered small would be determined substantially the same way as the thresholds for large or medium changes. If the required flow rate change is considered small, the system 10 can adjust the engine RPM (box 820). If the system 10 determines the required change is not small, the system 10 can continue operation with no adjustments to its operating parameters (box 822).

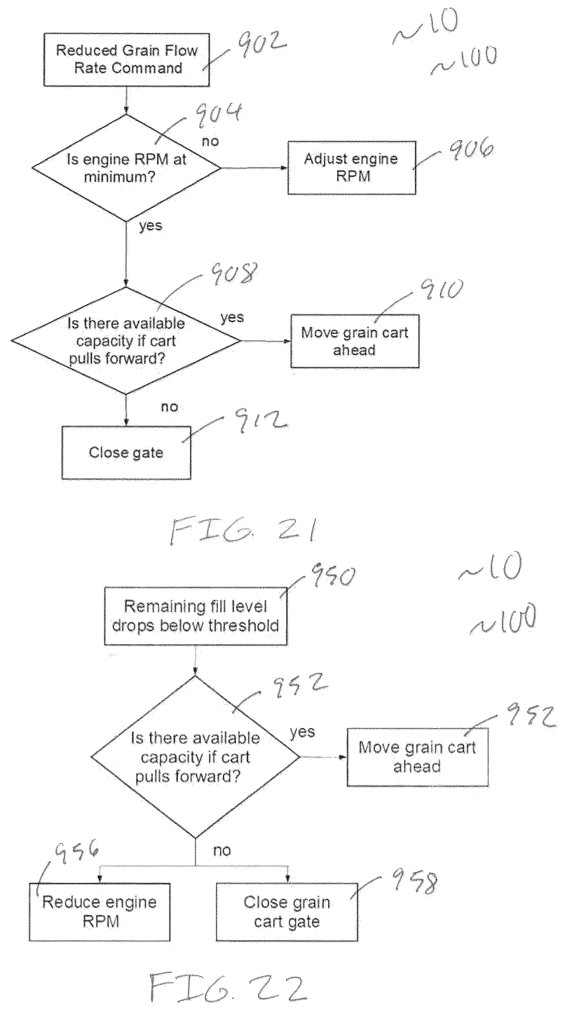

FIG. 21 shows the strategy of staged control actions for executing flow control, which can be present in certain implementations. In such implementations, the first control action for decreasing flow is to lower the engine RPM until the lower limit is reached, then move the vehicle if open volume is available and then close the grain cart unload gate.

In implementations with staged control actions, like shown in FIG. 21, the system 10, in executing an exemplary method 100 of operation, can receive a reduced grain flow rate command (box 902), such as from a user input. The system 10 can determine if the engine RPM is at the minimum value (box 904). If the system 10 determines that the engine is not at the minimum RPM, the system 10 can adjust the RPM to match the reduced grain flow required (box 906). If the engine RPM is at the minimum value, the system 10 can determine if there will be available capacity if the grain cart pulls forward (box 908). If there will be available capacity if the grain cart pulls forward, then the system 10 can move the grain cart forward (box 910). If there would not be available capacity as a result of pulling forward, the system can close the gate (box 912).

FIG. 22 defines the strategy for vehicle motion control (i.e., pulling the grain cart forward to change the unload position). To maximize the efficiency of the unload, the first action is move the grain cart to change the unloading position. In various implementations, there has to be open volume within the trailer that is available for unloading. If the unloading position has reached the end of the trailer or there is no open volume, the control actions can be some combination of reducing the engine RPM and closing the unload gate.

In implementations with grain cart motion control, like shown in FIG. 21-22, the system 10, in executing an exemplary method 100 of operation, can receive a signal when the remaining fill level drops below a certain threshold (box 950). The system 10 can determine if there will be available capacity in the grain truck if the grain cart pulls forward (box 952). If there will be available capacity in the grain truck if the grain cart pulls forward, the system 10 can pull the grain truck forward (box 954). If there will not be available capacity in the grain truck if the grain cart pulls forward, the system 10 can either reduce the engine RPM (box 956) or close the gate (box 958).

Although the disclosure has been described with reference to preferred embodiments, persons skilled in the art will recognize that changes can be made in form and detail without departing from the spirit and scope of the disclosed apparatus, systems and methods.

What is claimed is:

1. A grain unloading monitoring system comprising:
(a) at least one sensor configured to monitor a grain level within a grain container;
(b) a processor in electronic communication with the at least one sensor; and
(c) a command module in electronic communication with the processor, the command module configured to command one or more components on a grain cart or grain container to distribute unloaded grain and prevent overfilling of the grain container based on the monitored grain level and grain fill rate.

2. The grain unloading monitoring system of claim 1, wherein the processor is configured to determine a grain fill rate.

3. The grain unloading monitoring system of claim 1, wherein the one or more components comprise an auger and a gate.

4. The grain unloading monitoring system of claim 3, wherein the system is configured to slow the auger to prevent overfilling of the grain truck based on the monitored grain level and grain fill rate.

5. The grain unloading monitoring system of claim 3, wherein the system is configured to shut the gate to prevent overfilling of the grain container based on the monitored grain level and grain fill rate.

6. The grain unloading monitoring system of claim 2, wherein the system is configured to urge the grain cart or grain container fore or aft to distribute unloaded grain and prevent overfilling of the grain container based on the monitored grain level and grain fill rate.

7. The grain unloading monitoring system of claim 1, wherein the monitored grain level is monitored using a closed-loop control system.

8. The grain unloading monitoring system of claim 7, wherein the closed-loop control system uses a proportional gain response and an integral gain response to monitor the monitored grain level.

9. The grain unloading monitoring system of claim 1, wherein the grain fill rate is determined from a response calibration table.

10. The grain unloading monitoring system of claim 1, further comprising a sensor array configured to maintain distance between the grain container and grain cart.

11. The grain unloading monitoring system of claim 1, further comprising one or more reflectors positioned on a side wall of the grain container.

12. A grain unloading monitoring system comprising:
(a) at least one sensor configured to monitor a grain level within a grain container; and
(b) a command module configured to command one or more components on a grain cart or grain container to distribute unloaded grain and prevent overfilling of the grain truck based on the monitored grain level.

13. The grain unloading monitoring system of claim 12, further comprising a processor in electronic communication with one or more flow sensors, the one or more flow sensors configured to determine a grain fill rate.

14. The grain unloading monitoring system of claim 13, wherein the one or more components comprise an auger and a gate.

15. The grain unloading monitoring system of claim 14, wherein the system is configured to slow the auger to prevent overfilling of the grain truck based on the monitored grain level and grain fill rate.

16. The grain unloading monitoring system of claim 14, wherein the system is configured to shut the gate to prevent overfilling of the grain container based on the monitored grain level and grain fill rate.

17. The grain unloading monitoring system of claim 13, wherein the system is configured to pull the grain cart or grain container ahead to distribute unloaded grain and prevent overfilling of the grain container based on the monitored grain level and grain fill rate.

18. A grain unloading monitoring system comprising:
(a) at least one sensor configured to monitor a grain level within a grain container; and
(b) a command module configured to command one or more components on a grain cart or grain container to distribute unloaded grain and prevent overfilling of the grain container based on the monitored grain level and a grain fill level model.

19. The grain unloading monitoring system of claim 18, further comprising a processor in electronic communication with one or more flow sensors, the one or more flow sensors configured to determine a grain fill rate.

20. The grain unloading monitoring system of claim 19, wherein the monitored grain level is monitored using a closed-loop control system, wherein the closed-loop control system uses a proportional gain response, an integral gain response to monitor the monitored grain level, and grain flow rate model.
